(19) United States
(12) Patent Application Publication
(10) Pub. No.: US 2017/0277477 A1
(43) Pub. Date: Sep. 28, 2017

(54) Distributed Active Hybrid Storage System

(71) Applicant: Agency For Science, Technology And Research, Singapore (SG)

(72) Inventors: Weiya XI, Singapore (SG); Chao JIN, Singapore (SG); Khai Leong YONG, Singapore (SG); Pantelis ALEXOPOULOS, Singapore (SG)

(21) Appl. No.: 15/509,109

(22) PCT Filed: Oct. 2, 2015
(86) PCT No.: PCT/SG2015/050367

§ 371 Date: Mar. 6, 2017

(30) Foreign Application Priority Data
Oct. 3, 2014 (SG) 10201406349V

(51) Int. Cl. G06F 3/06; G06F 9/30; G06F 17/30

(52) U.S. Cl. CPC G06F 3/0685; G06F 17/30339; G06F 17/30722; G06F 9/3004

(57) ABSTRACT

An active storage system is disclosed. The active storage system includes a storage device, a non-volatile memory and an active drive controller. The active drive controller performs data management and/or cluster management within the active storage system, the active drive controller including a data interface for receiving at least object and/or file data.

### PRIORITY CLAIM

This application claims priority from Singapore Patent Application No. 10201406349V filed on Oct. 3, 2014.

### FIELD OF INVENTION

This invention is related to a storage system for a data center. More specifically, this invention is related to a distributed active hybrid storage system for a data center.

### BACKGROUND TO THE INVENTION

Current storage devices or volumes have little or no intelligence capabilities. They are dummy devices which can be instructed to perform simple read/write operations. It relies on a stack of system software in a storage server to abstract the block-based storage device. With more data in data centers, more storage servers are required to manage devices and provide storage abstraction. This increases not only hardware cost but also the cost of server maintenance.

With the advancement of Central Processing Unit (CPU) and Non-Volatile Memory (NVM) technologies, it is increasingly feasible to incorporate the functionalities of system and clustering software implementation and other data management into smaller controller board to optimize system efficiency and performances to reduce Total Cost of Ownership (TOC). The NVM is a solid state memory and storage technology for storing data at a very high speed and/or a very low latency access time, and the NVM retains the data stored even with the removal of power. Examples of NVM technologies include but are not limited to STT-MRAM (Spin torque transfer MRAM), ReRAM (Resistive RAM) and Flash memory. It is also possible the NVM may be provided by a hybrid or combination of the various different NVM technologies to achieve balance between cost and performance.

Thus, what is needed is a system for utilizing CPU and NVM technology to provide intelligence for storage devices and reduce or eliminate their reliance on storage servers for such intelligence. Furthermore, other desirable features and characteristics will become apparent from the subsequent detailed description and the appended claims, taken in conjunction with the accompanying drawings and this background of the disclosure.

### SUMMARY OF THE INVENTION

In accordance with one aspect of the present invention, an active storage system is disclosed. The active storage system includes a storage device, a non-volatile memory and an active drive controller. The active drive controller performs data management and/or cluster management within the active storage system, the active drive controller also includes a data interface for receiving at least object and/or file data.

In accordance with another aspect of the present invention, another active storage system is disclosed. The active storage system includes a metadata server and one or more active hybrid nodes. Each active hybrid node includes a plurality of Hybrid Object Storage Devices (HOSDs) and a corresponding plurality of active drive controllers, each of the plurality of active drive controllers including a data interface for receiving at least object and/or file data for its corresponding HOSD. One of the plurality of active drive controllers also includes an active management node, the active management node interacting with the metadata server and each of the plurality of HOSDs for managing and monitoring the active hybrid node.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present invention, by way of non-limiting example only.

Embodiments of the invention are described hereinafter with reference to the following drawings, in which:

FIG. 1 is an illustration depicting an example of an active drive storage system in accordance with a present embodiment.

FIG. 2 is an illustration depicting an example of an active drive distributed storage system architecture in accordance with the present embodiment.

FIG. 3 is an illustration depicting a block diagram of an example of an active drive storage system in accordance with the present embodiment.

FIG. 4 is an illustration depicting a view of one-to-one key value to object mapping in accordance with the present embodiment.

FIG. 5 is an illustration depicting a view of many-to-one key value to object mapping in accordance with the present embodiment.

FIG. 6 is an illustration depicting a view of one-to-many key value to object mapping in accordance with the present embodiment.

FIG. 7 is a block diagram depicting an example of active hybrid node (AHN) architecture in accordance with the present embodiment.

FIG. 8 is a block diagram depicting an example of an active management node (AMN) software architecture in accordance with the present embodiment.

FIG. 9 is a block diagram of a data update process in a conventional distributed storage system.

FIG. 10 is a block diagram of an exemplary network optimization of distributed active hybrid storage system in accordance with the present embodiment.

FIG. 11 is a flowchart depicting a programmable switch packet forwarding flow in a switch control board (SCB) in accordance with the present embodiment.

FIG. 12 is a flowchart depicting a reconstruction process when HOSD failures are encountered in accordance with the present embodiment.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present active storage systems which include active drive controllers coupled to hybrid storage devices within the systems for performing data management and cluster management, the cluster management including interaction with a metadata server and other active drive controllers to discover and join a cluster or to form and maintain a cluster. The active drive controllers in accordance with a present embodiment include a data interface for receiving object data, file data and key value data.

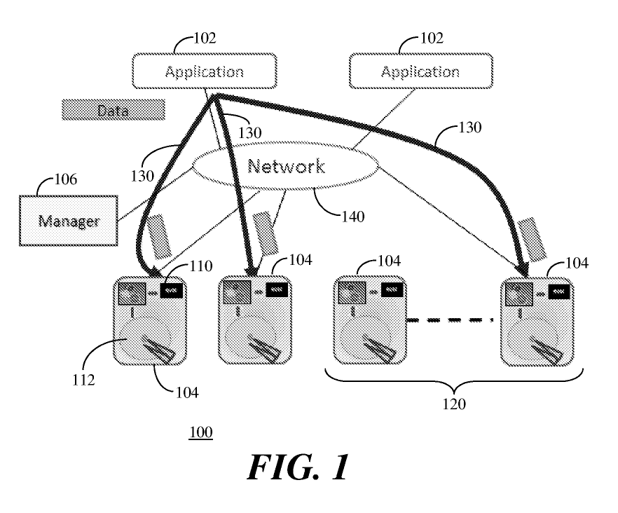

Referring to FIG. 1, an illustration depicts an example of an active drive storage system in accordance with a present embodiment system 100. The active drive storage system includes three main components: application servers 102, active hybrid nodes (AHNs) 104 and active management nodes (AMNs) 106. The AHN 104 is a hybrid storage node with a non-volatile memory (NVM) 110 and a hard disk drive (HDD) 112 attached. A plurality of AHNs 104 can be formed into a cluster 120. The AMN 106 contains a small amount of NVM as storage media. Packets of data 130 flow between the application servers 102 and the AHNs 104 via a network 140.

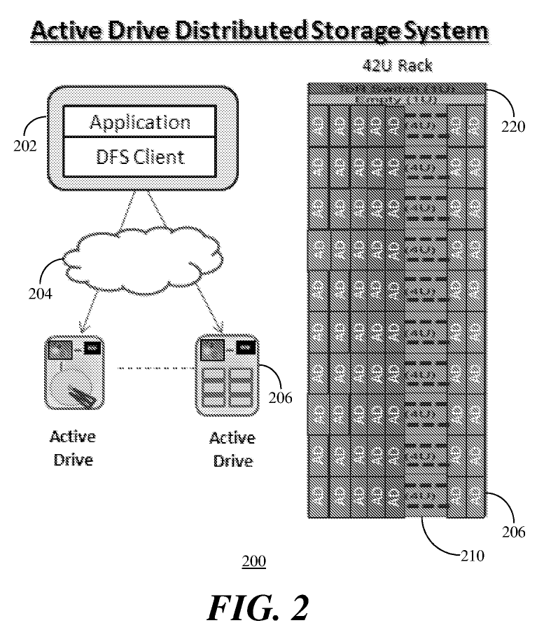

Referring to FIG. 2, an illustration depicts an example of an architecture for an active drive distributed storage system 200 in accordance with the present embodiment. The active drive distributed storage system includes an application/client server 202 coupled via the internet 204 to a plurality of active hybrid drives 206. In a data center configuration, the active hybrid drives 206 can be mounted in a rack such as a 42U Rack 210, the rack including a programmable switch 220 for coupling the active hybrid drives 206 mounted therein the application/client server 202. This architecture eliminates storage nodes with direct data transfer to the active hybrid drives 206.

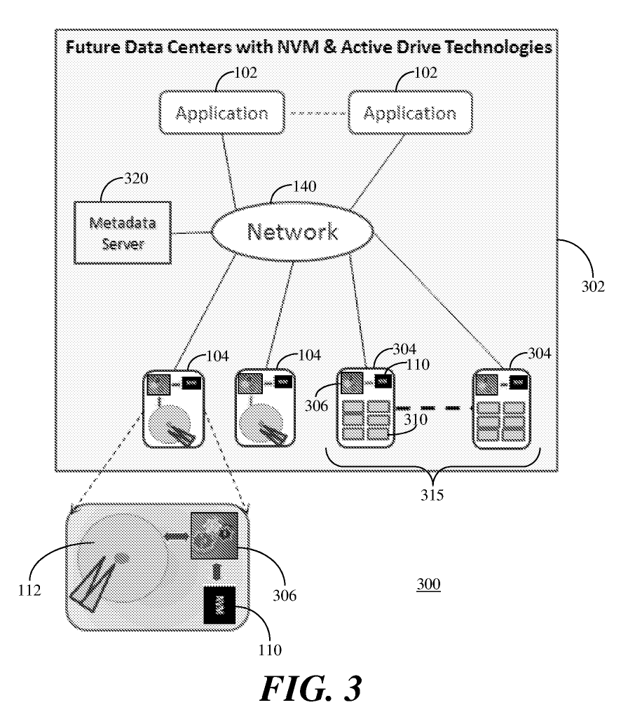

Referring to FIG. 3, a schematic view 300 of an example of a distributed active hybrid drive storage system 302 in accordance with the present embodiment is illustrated. The application servers 102 are coupled to the AHNs 104, 304, where some of the AHNs 104 include a NVM 110, a HDD 112 and an active drive controller 306 and other ones of the AHNs 304 include a NVM 110, a solid state drive (SSD) 310 and an active drive controller 306. A plurality of AHNs 104, 304 can be formed into a cluster 315. To improve performance and increase storage utilization, the distributed active hybrid storage system 302 adopts parallel data access and erasure codes. For data write, the application servers 102 can strip the data to different AHNs 104, 304, using a metadata server 320 to track the portions of data. During data read, the application servers 102 can simultaneous read multiple strips from different AHNs 104, 304 at the same time to achieve high performance.

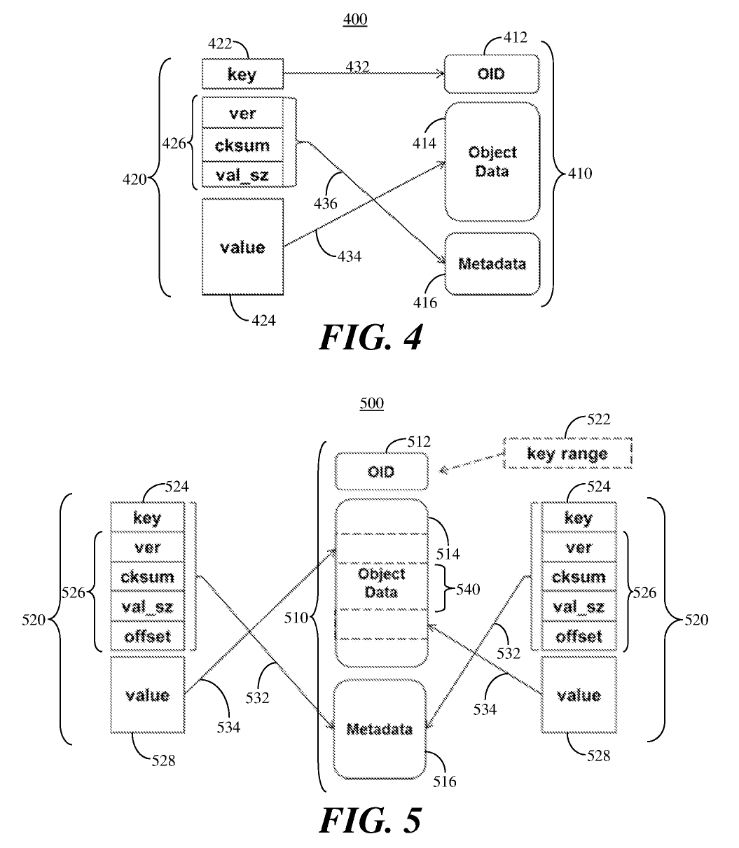

Referring to FIG. 4, a mapping illustration 400 depicts a view of one-to-one key value to object mapping in accordance with the present embodiment. An object 410 is composed of three parts: an object identification (OID) 412, object data 414, and object metadata 416. The OID 412 is the unique ID/name of the object 410. The object data 414 is the actual content of the object 410. And the object metadata 416 can be any predefined attributes or information of the object 410.

Key Value (KV) interfaces are built on top of the object store. A mapping layer is designed and implemented to map a KV entry 420 to an object 410. There are various mechanisms for mapping KV to Objects. In one-to-one mapping as depicted in the mapping illustration 400, each KV entry 420 is mapped to a single object 410. The KV entry 420 includes a key 422, a value 424 and other information 426. The key 422 is mapped 432 to the object ID 412. The value 424 is mapped 434 to the object data 414. And the other information 426 can include version, checksum and value size and is mapped 436 to the object metadata 416.

FIG. 5 depicts a mapping illustration 500 of a view of a many-to-one mapping scheme in accordance with the present embodiment. Multiple KV entries 520 are mapped to the same object 510. The object ID 512 represents a range of keys 522. KV entries 520 with keys falling into the range 522 are mapped to this object 510. For each entry 520, its key 524 and attributes 526 are mapped 532 to the object metadata 516. The attributes 526 can be found by searching the key 524 inside the object metadata 516. There is an attribute 526 stored in the object metadata 516 named ‘offset’, which represents an offset 540 of stored representations of the key values when each value 528 is mapped 534 to the object data 514.

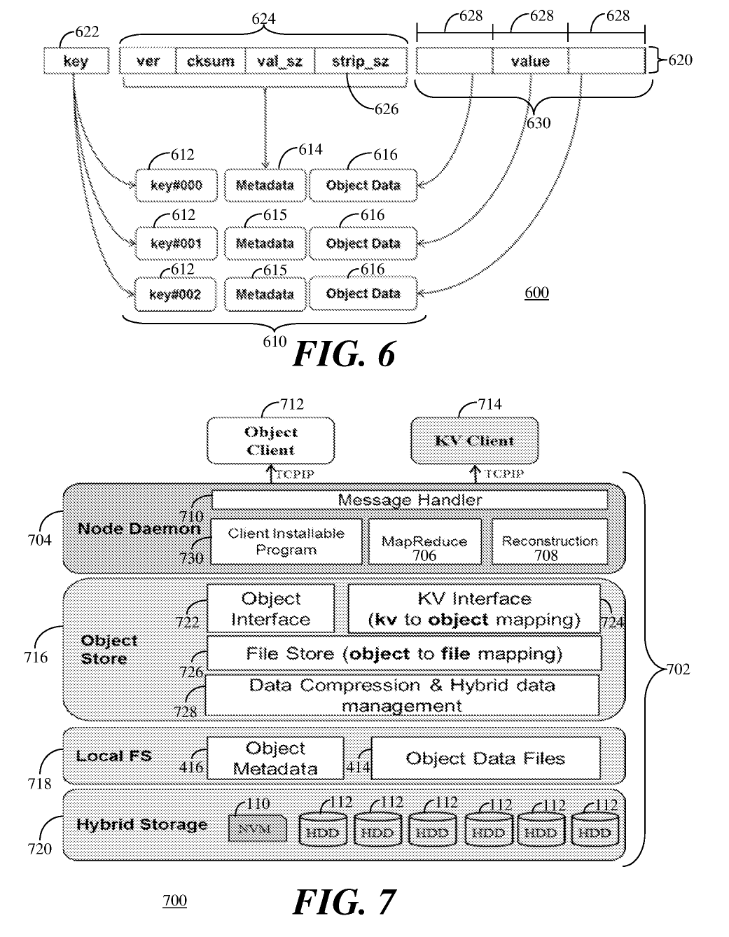

FIG. 6 depicts a mapping illustration 600 of a view of one-to-many key value to object mapping in accordance with the present embodiment wherein each KV entry 620 is mapped to multiple objects 610. The key 622 is mapped to multiple object IDs 612, with each object ID 612 being the key 622 combined with a suffix (#000, #001, etc.). The attributes 624 are stored in the metadata 614 of the first object 610. The attribute strip_sz 626 represents a fragment size 628 of the value 630 mapped to each object data 616. The last object data 616 can store fewer bytes than strip_sz 628. Alternatively, each object 610 can store a different size 628 of fragment and the individual size of the fragment is stored in the metadata of the object 614, 615.

Referring to FIG. 7, a block diagram 700 depicts an architecture of an AHN 702 with a node daemon 704. A daemon is a computer program that runs as a background process and there can be many daemons such as Hybrid Object Storage Device (HOSD) daemons which include one or multiple HOSDs or MapReduce Job 706 which can process MapReduce jobs when the AHN 702 is a storage node of a large Hadoop storage pool. There could also be other daemons implemented such as a reconstruction daemon 708 or a metadata sorting daemon (e.g., to sort data for local storage). Applications or client servers (e.g., servers 102) can post and install jobs into the AHN 702 for execution and a message handler 710 in the node daemon 704 provides message handling capability for the AHN 702 to communicate with the application/client server 102 where the client server may be an object client 712 or a key value (KV) client 714.

The AHN 702 also includes an object store 716, a local file storage 718 and hybrid storage 720, the hybrid storage 720 including HDDs 112 and NVMs 110. The local file storage includes the object metadata 416 (or the object metadata 516, 614, 615) and the object data files 414 (or the object data files 514, 616). The object store 716 includes an object interface 722 for interfacing with the object client 712 and a key value interface 724 for interfacing with the KV client 714. The key value interface 724 is responsible for KV to object mapping such as the mapping illustrated in FIGS. 4, 5 and 6 and a file store 726 in the object store 716 is responsible for object to file mapping. Data compression and hybrid data management 728 is also controlled form the object store 716.

The software architecture and modules that form the operations and functions of the AHN 702 are described in more detail. The software executables are stored in the non-volatile media for program code storage, and are recalled by the AHN processor into main memory during bootup for execution. The AHN 702 provides both object interfaces and key-value (KV) interfaces to applications in the object client server 712 and the KV client server 714. The object interfaces 722 are the native interfaces to the underlying object store 716. The object store 716 can alternatively be implemented as a file store (e.g., the file store 726) to store the objects as files.

There are three main layers of software: the node daemon 704, the object store 716 and the local file system 718. The node daemon layer 704 refers to various independent run-time programs or software daemons. The message handler daemon 710 handles the communication protocol based on TCP/IP with other ANHs, AMNs and client terminals for forming and maintaining the distributed cluster system and providing data transfer between client servers and the ANHs.

The reconstruction daemon 708 is responsible for executing the process of rebuilding lost data from failed drives in the system by decoding data from the associated surviving data and check code drives. The MapReduce daemon 706 provides the MapReduce and the Hadoop Distributed File System (HDFS) interfaces for the JobTracker in the MapReduce framework to assign data analytic tasks to ANHs for execution so that data needed for processing can be directly accessed locally in one of more storage devices in the ANH node. And the client installable program daemon 730 is configured to execute a program stored on any one or more storage devices attached to the ANH. As applications or client servers can post and install jobs into the AHN for execution, the client installable program daemon communicates with client terminals for uploading and installing executable programs into one or more storage devices attached to the ANH.

The principle of running data computing in the AHN 702 is to bring computation closer to storage, meaning that the daemon only needs to access data from a local AHN 702 for a majority of the time and send the results of the job back to the application or client server. In many situations, the results of the data computing are much smaller in size than the local data used for computation. In this way the amount of data need to be transmitted over the network 140 can be reduced and big data processing or computation can be distributed along with the storage resources to vastly improve total system performance.

The object store 716 is a software layer to provide object interface 722 and KV interface 724 to the node daemon layer 704. The object store layer 716 also maps objects to files by the file store 726 so that objects can be stored and managed by a file system underneath. Data compression and hybrid data management are the other two main modules in the object store layer 716 (though shown as the single module 728 in FIG. 7 for simplicity). Data compression performs in-line data encoding and decoding for data write and read, respectively, in accordance with the present embodiment. Hybrid data management manages the hybrid storage in accordance with the present embodiment so that often used data is stored in the NVM. Other data management services such as storage Quality of Service (QoS) can also be implemented in the object store layer 716.

The local file system layer 718 provides file system management of data blocks of the underlying one or more storage devices for storing of object metadata 416 and object data 414 by resolving each object into the corresponding sector blocks of the one or more storage devices. Data sector blocks for deleted objects are reclaimed by the local file system layer 718 in accordance with the present embodiment for future allocation of sector spaces for storing newly created objects.

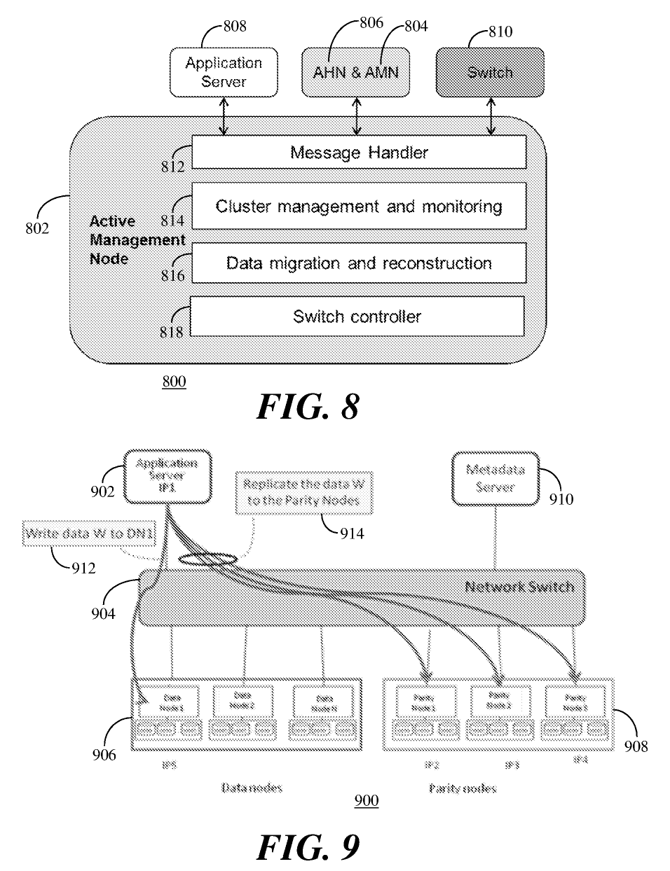

Referring to FIG. 8, a block diagram 800 depicts an example of software architecture of an active management node (AMN) 802 in accordance with the present embodiment. The AMN 802 can communicate with other AMNs (if any) 804, AHNs 806 in the cluster to which the AMN 802 belongs, application servers 808, and Switch Control Board (SCB) switches 810 via message handler daemon 812.

The AMN 802 is a multiple function node. Besides a cluster management and monitoring function 814, the AMN 802 sends instructions to migrate data due to new nodes added, or failed and inactive AHNs, or unbalanced data access to the AHNs from a Data migration and reconstruction daemon 816. In addition, the AMN 802 can also advantageously reduce network traffic by sending instructions via a switch controller daemon 818 to the SCB switches 810 to forward data packets to destinations not specified by a sender.

The message handler daemon 812 implements the communication protocols with other AMNs, if there are any, AHNs in the cluster, application servers, and the programmable switches. The cluster management and monitoring daemon 814 provides the algorithms and functions to form and maintain the information about the cluster. The client server communicates with the cluster management and monitoring daemon 814 to extract the latest HOSDs topology in the cluster for determining the corresponding HOSDs to store or retrieve data. Based on the monitoring status of the cluster, the AMN 802 sends instructions from the data migration and reconstruction daemon 816 to migrate data due to a new node added, or failed and inactive AHNs, or unbalanced data access to the AHNs. In addition, the AMN 802 can also send instructions to the programmable switches via the switch controller daemon 818 to replicate and forward data packets to the destinations autonomously to reduce load on the client communication.

Referring to FIG. 9, a block diagram 900 depicts a data update process in a conventional distributed storage system with erasure codes implemented for reliability. An application server 902 is coupled via a network switch 904 to storage which includes both data nodes 906 (i.e., DN1, DN2, . . . , DNn) and parity nodes 908 (i.e., PN1, PN2 and PN3). The parity nodes 908 maintain the coded data from DN1 to DNn such that every time data is written to a data node (e.g., data W written to DN1 at step 912), the data is replicated to the parity nodes 908 (e.g., data W is replicated to PN1, PN2 and PN3 at step 914). If the coded data for the parity nodes 908 are computed from Reed Solomon codes, the storage system can sustain three node failures at the same time. A metadata server 910 is also coupled to the data nodes 906 and parity nodes 908 via the network switch 904.

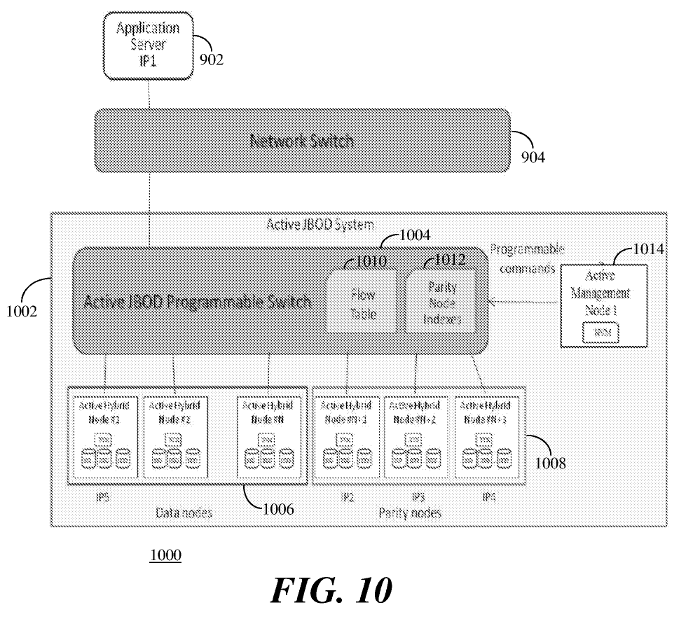

Referring to FIG. 10, a block diagram 1000 illustrates an exemplary network optimization of a distributed active hybrid storage system 1002 in accordance with the present embodiment. The application server 902 communicates with the distributed active hybrid storage system 1002 via the network switch 904. The network switch 904 interfaces with a programmable switch 1004 of the distributed active hybrid storage system 1002 to communicate with AHN data nodes 1006 and AHN parity nodes 1008. The programmable switch 1004 includes a flow table 1010 and parity node indexes 1012 and operates in response to programmable commands from an AMN 1014. The data nodes 1006 and parity nodes 1008 can be the HOSDs in an active hybrid drive storage cluster under the control of the AMN 1014. The data transfers between the application server 902 and the storage nodes (i.e., the data nodes 1006 and the parity nodes 1008) are over a network using TCP/IP as the transport and routing protocols. The data nodes 1006 and the parity nodes 1008 are active hybrid nodes such as the AHN 702 (FIG. 7) and relieve the application server 902 of sending multiple copies of data to different storage nodes using the software architecture of the active hybrid nodes 702. This structure also reduces the consumption of the data center network switch 904 bandwidth.

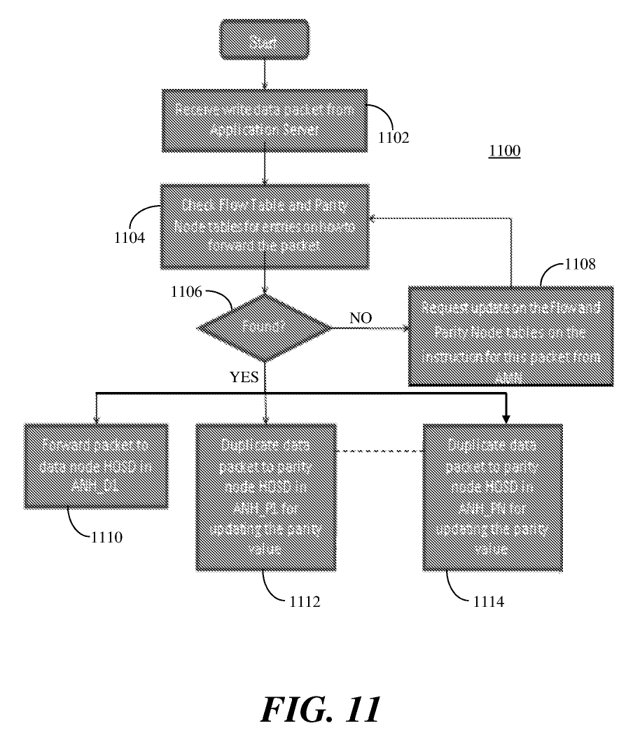

Referring to FIG. 11, a flowchart 1100 depicts a programmable switch packet forwarding flow in a switch control board (SCB) of the programmable switch 1004 (FIG. 10) in accordance with the present embodiment for forwarding incoming data from the application server 902. Upon receiving 1102 a data packet from the application server 902, the SCB of the programmable switch 1004 examines packet headers and corresponding payload parameter information and checks 1104 the flow table 1010 and the parity node tables 1012 to determine if the data packet is a write data packet and to which AHN node 1006 the packet should be forwarded.

In the event an associated entry is not found 1106 in the flow table, the packet headers and associated payload parameters are sent to the AMN 1014 to obtain a new entry for this packet or flow and the flow and parity node tables are updated 1108 in the programmable switch 1004 in accordance with the response received from the AMN 1014 which contains the new table entry information. When the entry is found 1106, the packet is forwarded 1110 to the AHN which contains the destination HOSD as indicated by the entry. Separate data write requests with the same data received from the application server 902 are duplicated 1112, 1114 by the programmable switch 1004 for forwarding to each of the parity nodes 1008 associated with the data node 1006 as listed in the corresponding entry in the parity node table 1012. Both parity nodes 1008 and data nodes 1006 are provided by HOSDs in the distributed storage cluster.

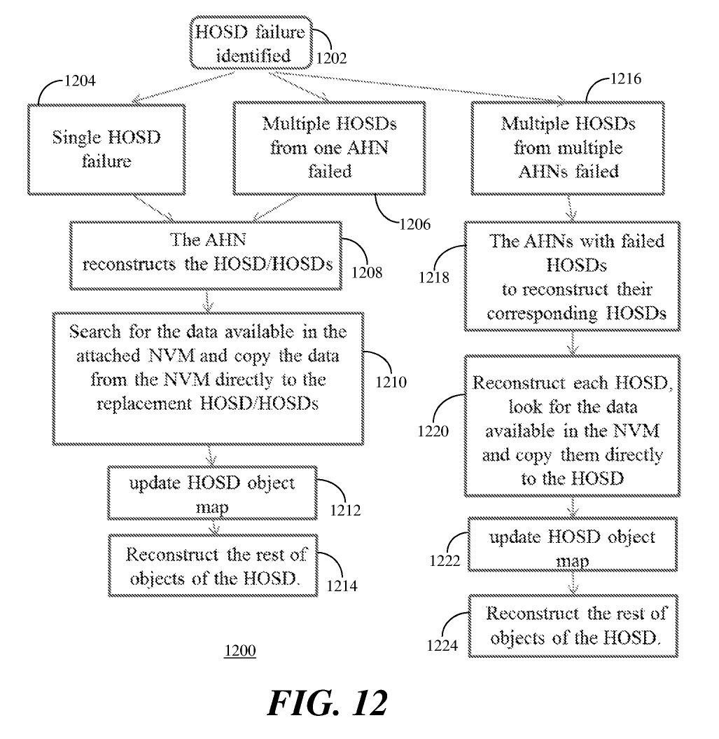

Referring to FIG. 12, a flowchart 1200 depicts a reconstruction process when one or more HOSD fail. Initially, an AHN identifies 1202 its attached HOSDs/HDDs failure. Once the replacement drive is identified, the reconstruction process starts. For the case of a single HOSD/HDD failure 1204 and failures 1206 of multiple HOSD/HDD which are from the same AHN, the reconstruction daemon 816 of the AMN 802 attached to the AHN where the HOSD failure occurs starts 1208 the reconstruction process using the object map the AHN 702 contains. First, the reconstruction daemon 816 searches 1210 for the data which is available in the attached NVM and copies it directly to the replacement HOSDs/HDDs. The object map which is also used as a reconstruction map is updated 1212 either after each object is reconstructed or after multiple objects are reconstructed 1214.

For the case of multiple HOSD/HDD failures occurring across different AHNs 1216, each AHN will be responsible for its own HOSD/HDD reconstruction 1218. For each AHN, the reconstruction procedure is the reconstruction daemon 816 looks 1220 for the data which is available in the attached NVM and copies it directly to the replacement HOSDs/HDDs and the object map which is also used as a reconstruction map is updated 1222 either after each object is reconstructed or after multiple objects are reconstructed 1214.

Thus, it can be seen that the present embodiment provides a system for utilizing CPU and NVM technology to provide intelligence for storage devices and reduce or eliminate their reliance on storage servers for such intelligence. In addition, it provides advantageous methods for reduced network communication by bringing data computation closer to data storage, and only forwarding results of the data computing which are much smaller in size than the local data used for computation across the network. In this way the amount of data needed to be transmitted over the network can be reduced and big data processing or computation can be distributed along with the storage resources to vastly improve total system performance. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. An active storage system comprising,
a storage device;
a non-volatile memory; and
an active drive controller, wherein the active drive controller is coupled to the storage device and the non-volatile memory and performs data management and/or cluster management within the active storage system, the active drive controller including a data interface for receiving at least key value data and/or object data,
wherein the data interface includes a first interface comprising an object interface for interfacing with the object data and a second interface comprising a key value interface for interfacing with the object data, the second interface comprising a mapping structure for mapping the key value data to the object data selected from the group comprising a one-to-one key value data to object data mapping structure, a many-to-one key value data to object data mapping structure and a one-to-many key value data to object data mapping structure.

2. The active storage system in accordance with claim 1, wherein the key value data includes keys, value data and other data, and wherein the mapping structure of the second interface comprises a one-to-one key value data to object data mapping structure which maps the value data to the object data, maps the keys to object IDs corresponding to the mapped object data, and maps the other data to object metadata corresponding to the mapped object data.

3. The active storage system in accordance with claim 1, wherein the data management comprises at least one of caching, compression, and Quality of Service (QoS).

4. The active storage system in accordance with claim 1, wherein the cluster management comprises interaction with a metadata server and peers to discover and join a cluster.

5. The active storage system in accordance with claim 4, wherein the cluster management further comprises interaction with the metadata server and peers to form and maintain a cluster.

6. The active storage system in accordance with claim 1, further comprising an installable program to allow user/clients to download and execute the program within the active storage system.

7. The active storage system in accordance with claim 1, further comprising one or more Hybrid Object Storage Device (HOSD) daemons.

8. The active storage system in accordance with claim 1, wherein the active storage system controls a programmable switch.

9. An active drive distributed storage system comprising:
a metadata server; and
one or more active hybrid nodes, each active hybrid node comprising a plurality of active drive storage devices, each active drive storage device comprising an active drive controller, each active drive controller including a data interface for receiving at least key value data and/or object data for its corresponding one of the plurality of active storage devices, wherein the data interface includes a first interface comprising an object interface for interfacing with the object data and a second interface comprising a key value interface for interfacing with the object data, the second interface comprising a mapping structure for mapping the key value data to the object data selected from the group comprising a one-to-one key value data to object data mapping structure, a many-to-one key value data to object data mapping structure and a one-to-many key value data to object data mapping structure, and
wherein the active drive controller of one of the plurality of active drive storage devices in each of the one or more active hybrid nodes is coupled to an active management node, the active drive controller of the one of the plurality of active drive storage devices interacting with the metadata server and other ones of the plurality of active drive storage devices via the active management node for managing and monitoring the active hybrid node.

10. The active storage system in accordance with claim 9, wherein the key value data includes keys, value data and other data, and wherein the mapping structure of the second interface comprises a one-to-one key value data to object data mapping structure which maps the value data to the object data, maps the keys to object IDs corresponding to the mapped object data, and maps the other data to object metadata corresponding to the mapped object data.

11. The active storage system in accordance with claim 9, wherein each of the plurality of active drive storage devices comprises Hybrid Object Storage Device (HOSD) daemons.

12. The active storage system in accordance with claim 9, wherein each active drive controller further performs data management comprising at least one of caching, compression, and Quality of Service (QoS).

13. The active storage system in accordance with claim 9, wherein the active management node instructs data migration within the active hybrid node in response to one or more of an addition of a new active hybrid node, a failure of one of the one or more active hybrid nodes and unbalanced data access to its corresponding active hybrid node.

14. The active storage system in accordance with claim 9, further comprising an installable program to allow user/clients to download and execute the program within the active storage system.

15. An active drive distributed storage system comprising:
a metadata server; and
one or more active hybrid nodes, each active hybrid node comprising a plurality of active drive storage devices, each active drive storage device comprising an active drive controller, each active drive controller including a data interface for receiving at least key value data and/or object data for its corresponding one of the plurality of active storage devices,
wherein an active drive controller of one of the plurality of active drive storage devices in each of the one or more active hybrid nodes further is coupled to an active management node, the active drive controller of the one of the plurality of active drive storage devices interacting with the metadata server and other ones of the plurality of active drive storage devices via the active management node for managing and monitoring the active hybrid node, and wherein the active storage system controls a programmable switch, and wherein the active management node forwards instruction to the programmable switch to forward data packets to destinations not specified by a sender in order to reduce network traffic.

16. The active storage system in accordance with claim 1, wherein the key value data includes a plurality of key value entries, each of the plurality of key value entries comprising a key, attributes and value data, and wherein the mapping structure of the second interface comprises a many-to-one key value data to object data mapping structure which maps multiple ones of the plurality of key value entries to one object data, wherein an object ID data corresponding to the mapped object data corresponds to a range of keys, and wherein the keys and the corresponding attributes are mapped to object metadata corresponding to the mapped object data.

17. The active storage system in accordance with claim 1, wherein the key value data includes a plurality of key value entries, each of the plurality of key value entries comprising a key, attributes and value data, and wherein the mapping structure of the second interface comprises a one-to-many key value data to object data mapping structure which maps each of the plurality of key value entries to multiple object data, wherein each key is mapped to multiple object ID data corresponding to the mapped multiple object data, and wherein the attributes corresponding to the plurality of key value entries are represented by object metadata of a first one of the mapped object data.

18. The active storage system in accordance with claim 9, wherein the key value data includes a plurality of key value entries, each of the plurality of key value entries comprising a key, attributes and value data, and wherein the mapping structure of the second interface comprises a many-to-one key value data to object data mapping structure which maps multiple ones of the plurality of key value entries to one object data, wherein an object ID data corresponding to the mapped object data corresponds to a range of keys, and wherein the keys and the corresponding attributes are mapped to object metadata corresponding to the mapped object data.

19. The active storage system in accordance with claim 9, wherein the key value data includes a plurality of key value entries, each of the plurality of key value entries comprising a key, attributes and value data, and wherein the mapping structure of the second interface comprises a one-to-many key value data to object data mapping structure which maps each of the plurality of key value entries to multiple object data, wherein each key is mapped to multiple object ID data corresponding to the mapped multiple object data, and wherein the attributes corresponding to the plurality of key value entries are represented by object metadata of a first one of the mapped object data.
